(19) United States
(12) Patent Application Publication
(10) Pub. No.: US 2008/0067211 A1
(43) Pub. Date: Mar. 20, 2008

(54) Duct Tape Dispenser With Holder

(76) Inventors: Richard W. Steele, Traverse City, MI (US); Wendy Steele, Traverse City, MI (US)

Correspondence Address: MCGARRY BAIR PC, 32 Market Ave. SW, SUITE 500, GRAND RAPIDS, MI, 49503, US

(21) Appl. No.: 11/532,515

(22) Filed: Sep. 16, 2006

(51) Int. Cl. B44C 7/00

(52) U.S. Cl. 225/77; 156/577

(57) ABSTRACT

A tape dispenser, useful for storing, dispensing, and cutting a roll of duct tape, or similar wide, heavy, hard-to-tear tape. The dispenser is formed in two axially-registered and rotationally-mated halves. The dispenser can also include a mating wall-mounted or shelf-mounted receptacle that releasably mounts the dispenser on a convenient surface, and that allows tape to be dispensed and torn with one hand from the receptacle-mounted dispenser.

### FIELD OF THE INVENTION

The present invention is in the field of dispensers for pressure-applied adhesive tape.

### BACKGROUND OF THE INVENTION AND DESCRIPTION OF RELATED ART

Dispensers for large rolls of tape have been known for many years. Most seem to be designed for packaging tape. While professional packagers often use heavy, handle-equipped dispensers that look somewhat like large handguns, most dispensers for the average user seem to have split arms that bracket the sidewalls of the roll, with curved or cylindrical spool supports extending inwardly from the split arms into the tape's spool to rotationally support the roll between the arms. The arms extend away from the surface of the roll, and a cutting element is held between the ends of the arms away from the roll, the cutting element oriented generally parallel to the tape-feed direction. The arms typically have spaced guide/retainer tabs associated with the cutting element, apparently to either help direct the tape toward the cutting element when the tape is being applied directly to a package in a continuous strip, and/or to catch and hold the cut end of tape away from the roll's surface. Examples include U.S. Pat. No. 6,719,180 to Shah and U.S. Pat. No. 6,923,358 to Chandaria.

Another general style of dispenser has an open-faced sidewall with a cylindrical spool support, and a top wall located above a portion of the face of the roll with a cutting element built into the forward end of the top wall. Examples include U.S. Pat. No. 6,695,190 to Gunter, Jr. et al., U.S. Pat. No. 3,134,526 to Schleicher, and U.S. Pat. No. 4,130,229 to Pagnini. These seem to rely on the cutting element to catch and hold the cut end of tape.

An older, third style of tape dispenser that no longer appears to be popular is really more of a minimalist cutting device, in which a cutting element is held directly against the face of the roll of tape by a spool holder rotationally engaging the inner diameter of the roll. Examples include U.S. Pat. No. 2,262,260 to Smith and U.S. Pat. No. 3,970,230 to Horn. These cutters do not appear to have the ability to catch and hold the cut end of tape.

Prior tape dispensers seem to be primarily designed for easily-cut, lightweight tapes such as thin-film packaging tapes and masking tapes. As such they appear to be lightly built, with open housings or thin, flexible members that make them easy to reload with a fresh roll of tape, but that in my opinion make them unsuitable or undesirable for dispensing and cutting one of the most popular and widely used rolls of tape found today in the average household or workshop: duct tape. As a result, duct tape seems to be exclusively sold in plain rolls. Anyone who has used duct tape, known for its width and sticky strength, has likely found it difficult to peel the cut end off the roll and to tear it (requiring both hands) while in the middle of a task.

Another disadvantage of many prior tape dispensers is their apparent lack of utility for conveniently storing a roll of tape between uses, and plain rolls of duct tape are semi-legendary for being misplaced between uses and unavailable when needed. Yet another disadvantage of prior tape dispensers is their inability to provide one-handed dispensing and cutting while stationary, especially for wider tapes that are more difficult to dispense and tear.

Our co-pending U.S. application Ser. No. 11/383,807 filed May 17, 2006 discloses a combined tape dispenser and cutter (hereafter “dispenser”) especially adapted for wide, heavy, hard-to-tear tapes such as duct tape and its equivalents (for example “hundred-mile-an-hour” tape, “duck” tape, “Gorilla™” tape), but also useful for other types and strengths of tape. The dispenser surrounds a circumferential section of the roll of tape (inner spool wall, roll sidewalls, and roll top or outer surface). The dispenser includes a spool support for rotationally mounting a roll of tape, two sidewalls, and a top having top wall, cutting bar, and retainer bar portions spaced by tape-stop and tape-feed openings large enough for finger and/or thumb access to the roll on each side of the cutting bar. The cutting bar is vertically offset above the top wall and retainer bar portions, with a horizontal cutting element generally parallel to the roll of tape (and thus generally perpendicular to the tape feed direction). The housing is preferably made from a rigid material that, along with the roll-surrounding nature of the dispenser, gives the user good control and leverage over the roll of tape while dispensing and cutting it.

The dispenser housing in the co-pending application is formed from two substantially rigid, axially-separable halves, with a magnetic axial connection between the two axially separable halves of the housing. In one form the magnetic connection is shearable using one or more flush-mounted magnets; in another form the magnetic connection uses a post-and-socket structure that provides both axial magnetic connection and an anti-rotational, shear-resistant mechanical connection.

The dispenser in the co-pending application can also be removably coupled to an inventive bracket that securely stores the dispenser under a cabinet or shelf or against a wall for storage while allowing the tape to be cut and dispensed with one hand from the bracket-mounted dispenser. The bracket has a cantilevered front arm designed to couple with an exterior magnet on the top of the dispenser.

### BRIEF SUMMARY OF THE INVENTION

The present invention is a dispenser formed in two substantially rigid halves that rotationally mount a roll of duct tape or similar heavy duty tape on a spool support between them, the dispenser halves being two axially-registering, rotationally-locking portions, with an initial axial registration through the spool on the roll of tape, and then an opposing rotational connection to mate and lock the dispenser halves.

The sidewalls are joined and reinforced by a top wall and cutting bar spaced apart by a tape-feed opening that provides finger access to the roll of tape. The top wall is radially split into rotationally mating halves. The cutting bar can optionally be split in similar fashion into rotationally mating halves, but in the preferred form the cutting bar extends as a unitary piece from one of the sidewalls, rotationally engaging a locking tab on the opposite sidewall as the dispenser halves are mated. The unitary cutting bar supports the full width of a cutting element that in the preferred form is a metal blade.

The cutting bar is radially spaced farther from the roll of tape than the top wall, and is held between sidewall extensions that are reversely angled back toward the top wall, such that the cutting element points upwardly toward the sticky underside of the leading end of the tape as it crosses the cutting bar, and back toward a user holding the dispenser by the top wall. The cutting element is substantially parallel to the surface of the roll of tape, such that a user's hand grasping the leading end of the tape while tearing it remains forward of the cutting element. In a preferred form, the cutting bar is spaced from the dispenser sidewalls by extensions that define a deep, preferably rounded finger well below the leading end of the tape stretched from the roll to the cutting bar.

Another feature of the present invention is a removable belt clip that releasably mates with a socket formed in one of the sidewalls and top wall portions. In the preferred form both sidewalls are provided with a socket, so that the user can switch the belt clip to opposite sides of the dispenser.

The dispenser is self-standing in a manner that makes it easy to grasp, prevents the tape from rolling away, and is conspicuous, reducing the likelihood that the roll of tape will be misplaced. The dispenser further preferably includes a mating receptacle that removably mounts the dispenser under a cabinet or shelf or flush against a wall for storage, and allows the tape to be cut and dispensed with one hand from the receptacle. In the present invention, the receptacle is a rigid molded unit with a rounded contour for mating with the arcuate top wall of the dispenser, the rear of the top wall initially engaging a shelf on the receptacle, and the remainder of the top wall then being rotated up into locking engagement with the receptacle. The receptacle has a locking lever operated from the exterior of the mated dispenser and receptacle to lock and release the front edge of the dispenser's top wall.

These and other features and advantages of the invention will become apparent upon further reading of the specification in light of the accompanying drawings.

### BRIEF DESCRIPTION OF THE DRAWINGS

FIG. 1 is a front perspective view of a tape dispenser according to the present invention.

FIG. 2 is a side elevation view of the tape dispenser of FIG. 1, with a user's hand shown in phantom.

FIG. 3 is a perspective view of the interiors of the separated halves of the dispenser of FIG. 1.

FIG. 3A is a perspective view of the dispenser halves of FIG. 1 with their respective spool halves axially registered, prior to being rotated into locking engagement.

FIG. 3B is similar to FIG. 3A, but with the dispenser halves rotated into partial locking engagement.

FIG. 4 is a perspective view of the dispenser of FIG. 1, fully mated, the dispenser shown exploded from a mating storage/dispensing receptacle mounted on the underside of a shelf.

FIG. 4A shows the dispenser in a first stage of attachment to the receptacle of FIG. 4.

FIG. 4B shows the dispenser fully attached to the receptacle of FIG. 4, the locking lever shown in its release position in phantom.

FIG. 4C is a side elevation view of the united dispenser and receptacle of FIG. 4B, in which a front portion of the dispenser is cut away to illustrate the locking lever and its connection to the dispenser.

FIG. 5 is a perspective view of the dispenser of FIG. 1, with a removable belt clip shown exploded from its mounting socket in the dispenser sidewall.

### DETAILED DESCRIPTION OF THE INVENTION

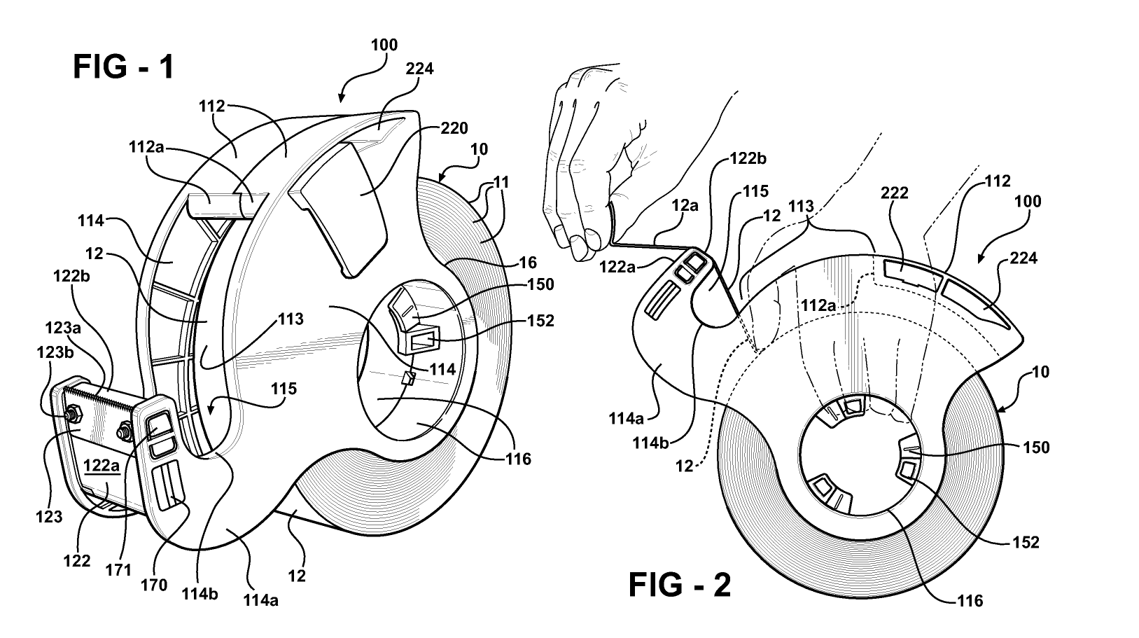

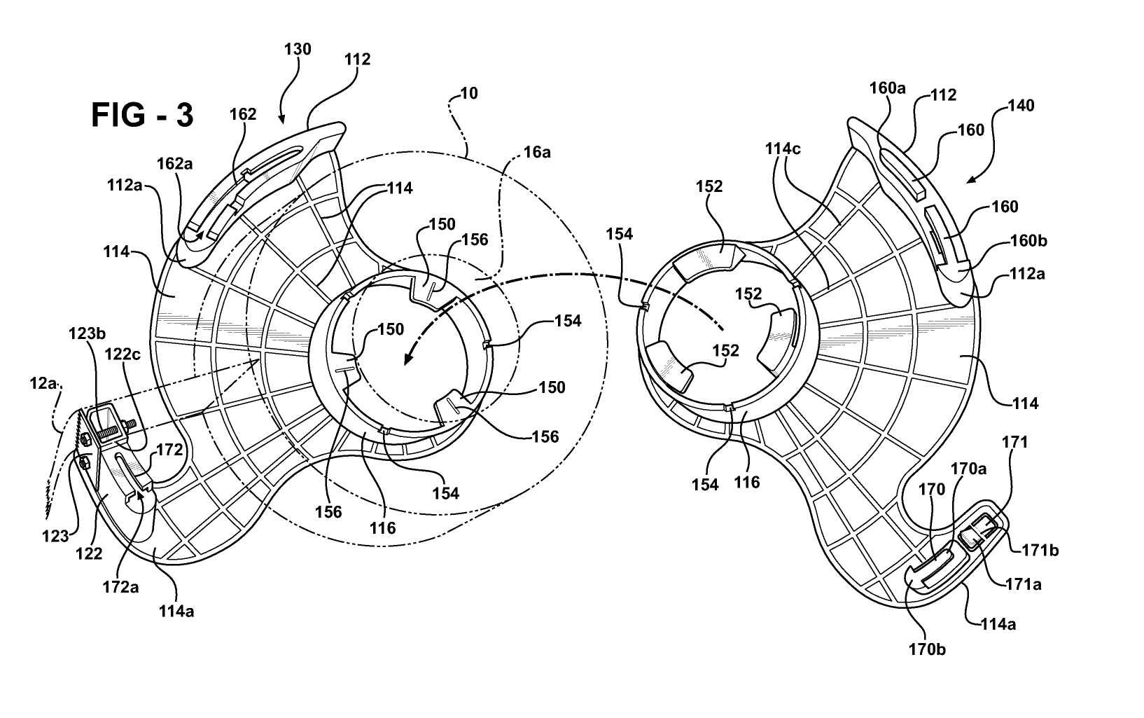

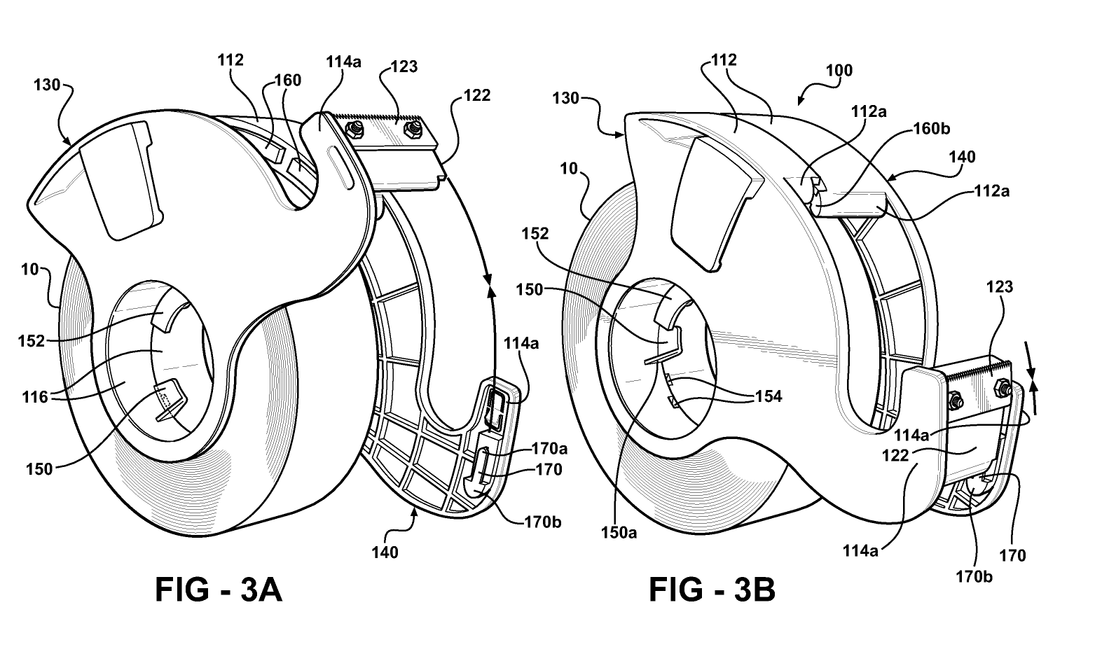

Referring to FIGS. 1 and 2, a common roll of duct tape 10 (most commonly gray, but increasingly in a variety of colors, two or three inches wide, heavy, waterproof, hard to tear, possibly reinforced, and sometimes—perhaps originally—called “duck” tape) is shown held in a dispenser 1 00 according to a preferred example of the present invention. Roll 10 is formed in known manner from multiple layers of tape 11 wound around a spool 16, the spool usually being made of cardboard although other materials are possible. The roll has a top or outer surface 12 consisting of the outermost layer of tape, sides 14 formed by the multiple thicknesses of wound tape (and the spool edges), and an inner diameter or surface 16a (FIG. 3) which is the inner wall of spool 16.

Dispenser 100 has a top wall portion 112 spaced from and generally following the curvature of the outer surface 12 of roll 10; sidewalls 114 spaced from and generally parallel to roll sides 14; and a spool support 116 extending from one dispenser sidewall 114 through spool 16 to the other sidewall 114, the spool support 116 engaging the inner spool diameter 16a with a low friction surface such that roll 10 rotates smoothly and easily on support 116. In the illustrated embodiment, dispenser 100 covers a circumferential section of roll 10, for example extending around approximately a quarter to a third of the roll's circumference. It will be understood that this fraction can vary, but given the rotationally-locked dispenser halves described in further detail below, the dispenser top wall 112 should extend around no more than half the circumference of the dispenser.

While in the illustrated embodiment of FIGS. 1 and 2 the spool support 116 is shown as a full cylinder and the dispenser sidewalls 114 are spaced from the sides of roll 10, it will be understood that the spool support could present less than a continuous cylinder surface to the tape spool, and the dispenser sidewalls could engage the sides of the tape roll, provided the friction between the surfaces of the dispenser and the roll of tape are not enough to unduly hinder rotation of the roll in the dispenser.

The forward (tape-dispensing) end of dispenser 100 supports a raised cutting bar 122 spaced farther than top wall 112 from the surface 12 of roll 10, and spaced circumferentially from the forward edge 112a of top wall 112 to leave a combined tape-feed and tape-stop opening 113 (hereafter referred to simply as “tape-feed opening”). In the preferred, illustrated form, cutting bar 122 is supported between upper ends of raised, reversely-curved or angled extensions 114a of sidewalls 114, with the sidewall upper edges 114b defining a deep, rounded finger well 115 located below the leading end 12a of tape 12 when the tape is stretched from roll 10 to cutting bar 122 (best shown in FIG. 2).

It should be understood that the term “bar” is not intended to unduly limit the shape or size of cutting bar 122, except to the extent that it is sufficiently long to connect the sidewalls, sufficiently high to present a significant tape-retaining face 122a below the cutting element, and sufficiently strong and rigid to support the cutting element, to reinforce the assembled halves of the dispenser housing, and to withstand the force of the tape being dispensed and cut when secured between the sidewalls.

Dispenser 100 is preferably made from a thick-walled, relatively rigid plastic material such that the assembled dispenser 100 is substantially rigid, with little or no flex under the stress of unwinding and tearing tape off roll 10. By way of example, dispenser 100 in the illustrated embodiment has a spool support and side walls on the order of 0.25 inches thick, and the top wall and cutting and retainer bars are preferably as thick or thicker. The illustrated example can be made for example from glass-reinforced nylon, and other suitable plastics are believed to include, but are not limited to, ABS, polycarbonate, nylons, polypropylenes, and other common polymer materials, and known molding processes are believed to be suitable for manufacturing the dispenser. It will also be understood that dispenser 100 could be made from other materials, including wood and metal, or from combinations of the above materials.

The spool support 116, top wall 112, and cutting bar 122 bridge the sidewalls 114, axially connecting and reinforcing sidewalls 114 across the roll of tape both above and below the circumferential, annular section of roll 10 encompassed by the dispenser. Coupled with the substantially rigid materials used, this makes dispenser 100 a strong, rigid, easily-controlled platform for dispensing and cutting even heavy, hard-to-tear tape from roll 10.

The outer surface 122a of plastic cutting bar 122 includes a cutting element 123, in the illustrated embodiment a serrated metal blade of a type known for cutting adhesive tape, with its cutting edge 123a arranged pointing upwardly and generally parallel to the adjacent surface 12 of the roll of tape and generally perpendicular to the tape feed direction off the roll. Cutting element 123 can be secured permanently or removably to the upper portion of the outer face 122a of the cutting bar using any known means or process, including but not limited to adhesives, mechanical fasteners (such as those illustrated at 123b), and plastic welding methods. It will be understood that while a separate metal cutting element is illustrated, cutting elements formed of other materials or molded or machined integrally in the material of cutting bar 122 are possible.

Cutting bar 122 in the preferred, illustrated embodiment has a wide, flat upper surface 122b to automatically retain the just-cut leading end 12a of the tape next to the cutting element 123, as best shown in FIG. 2. The even wider flat outer face 122a of cutting bar 122 allows the leading end 12a of tape 12 to be wrapped over and around the cutting element 123 and stored on outer face 122a for convenient storage that keeps the cutting edge 123b of cutting element 123 covered during storage, and that keeps the user's fingers away from the cutting edge while peeling the leading end of the tape off the dispenser. It will be understood that while cutting bar 122 is illustrated with a preferred rectangular cross-section, other cross-sectional shapes are possible for cutting bar 122.

It will further be understood that the edges of the top wall portion 112 and the cutting bar 122 bordering the tape-feed opening 113 and the finger well 115 are preferably rounded or beveled to avoid discomfort to a user's fingers.

The tape-feed opening 113 is an arcuate opening defined by the sidewall top edges 114b. Referring to FIGS. 2 and 3, the opening 113 easily allows one or more fingers or a thumb from the hand holding dispenser 100 to be conveniently and comfortably inserted to control the tape being dispensed and to stop the roll 10 from rotating when a piece of tape dispensed from opening 113 is being cut. The long, curved tape-feed opening 113 (especially in conjunction with finger well 115) also allows a thumb and forefinger good access to the leading end 12a of the tape held off the face of roll 10 by the cutting bar 122, first to help peel the tape off the cutting bar and then to easily dispense the desired length by pulling it off the roll of tape at a dispensing angle generally perpendicular to the tape roll and to cutting blade 123 before pulling it down across the upwardly-pointing cutting bar 122 to sever the tape from the roll. Tape-feed opening 113 also preferably allows peeling and retrieval of the cut end of the tape from the surface of roll 10 for placement onto cutting bar 122 without having to disassemble the dispenser.

Referring next to FIG. 3, dispenser 100 is shown separated into halves 130 and 140, for example to replace an empty roll of tape with a new roll. It should be understood that the use of “halves” to describe the axially registered, rotationally separable parts 130 and 140 of dispenser 100 is not intended to limit the invention to two identical or symmetrical pieces, or be proportionally true halves, but is merely for convenience of explanation. The same is true of the descriptions of the split top wall and spool support “halves”, i.e. they need not be identical or symmetrical or proportionally-exact half portions. “Axially registered” means that the two halves 130 and 140 are initially brought together in a direction essentially parallel to the rotational axis of tape roll 10 on tape spool 16, to the point where their inside edge of the dispenser halves are touching and their respective rotational locking features are aligned for subsequent rotational connection.

The radially split, axially registering, rotationally locking bayonet motion and structure of the dispenser halves is best illustrated in FIGS. 3, 3A, and 3B. It should further be understood that although some portions of dispenser 100 common to both dispenser halves are not identical given the differences in their mating locking structures, they are given the same reference numeral; examples include spool support halves 116, sidewalls 114, and top wall portions 112, because they appear to be essentially identical or to be unitary pieces when the dispenser is fully assembled. By “radially” split is meant a split or divide generally perpendicular to the rotational axis of the roll of tape on the dispenser.

Referring first to FIG. 3, dispenser halves 130 and 140 have been axially separated to put a roll of tape on one of the spool support halves 116 (the spool support 116 half on dispenser half 130 in the drawings, although it could go on either). The dispenser halves 130 and 140 are then brought together axially as shown by the arrow to join the edges of the spool support halves 116 through tape spool 16, temporarily holding the roll 10 in place between the dispenser halves, and further aligning the rotational locking structures on the spool support halves 116, the cutting bar 122 and opposing sidewall, and the split top wall portions 112.

FIG. 3A shows the axially registered dispenser halves 130 and 140 before they are rotated into locking engagement. The locking motion can be accomplished by holding one dispenser half in place and rotating the other half into it, or the locking motion can be accomplished in the preferred manner which is to rotate both dispenser halves in opposing directions until the are fully mated, as indicated by the arrows. In the illustrated embodiment, top wall 112 is radially split into two essentially equal portions whose inside edges are provided with rotationally mating locking structures 160 and 162 (best shown in FIG. 3), while cutting bar 122 extends essentially fully from sidewall extension 114a on dispenser half 130 and its free end is locked to the other sidewall extension on half 140 by rotationally mating locking structures 170 and 172 (best shown in FIG. 3). The spool support halves 116 are provided with rotationally mating tabs and lugs 150,152. It will be understood that the extent to which any or all of spool support 116, cutting bar 122, and top wall 112 are split radially into mating “halves” can vary, with different combinations and proportions possible, and even with all of these three sidewall-joining axial reinforcing structures extending mostly or fully from one dispenser half, the other dispenser half being essentially a sidewall with rotational locking structure.

The use of a full, unitary cutting bar 122 extending from a single sidewall and supporting the full length of cutting blade 123 also allows the leading end 12a of the tape to be secured to retainer bar 124 before assembling the dispenser halves together, and prevents the roll of tape from falling off the half spool support (and prevents undue stress on the retainer bar) if the leading end of the tape is still attached to the retainer bar when the dispenser halves are separated.

Still referring to FIG. 3, the preferred rotational locking structures 160,162 and 170, 172 are tongue-and-groove type, albeit arcuate for a rotational mating engagement. One or more tongues 160 extending from the split inside face of right-hand top wall portion 112 has a rounded or beveled leading tip 160 that is rotated into opening 162a of mating groove 162 formed in the opposite inside face of left-hand top wall portion 112. A widened stop or shoulder 160b positively limits the rotational connection so that the dispenser halves cannot be over-rotated.

The cutting bar tongue and groove structures 170 and 172 are preferably initially engaged after the top wall locking structures 160 and 162 are engaged, as illustrated, with the leading end 170a of tongue initially entering open end 172a of groove 172 on the inside face of cutting bar 122, and stop 170b contacts the open end 172a at the same time that stop 160b abuts top wall groove entrance 162a, for a positive and simultaneous lock. Structures 170 and 172 are also curved to accommodate the rotational closing motion of the dispenser halves.

On spool supports 116, locking tabs 150 and locking lugs 152 begin and end their rotational locking engagement simultaneously with the engagement of tongue-and-groove locking structures 160,162 and 170,172. Tabs 150 in the illustrated embodiment are generally L-shaped structures with tapered flats 150 making a sliding cam engagement with ramped lugs 152, and upright stop portions 150a positively limiting any further rotation of the spool support portions 116. Although the end of the rotational locking motion can be clearly felt given the simultaneous positive mechanical contact with stops 160b, 170b, and uprights 150a, spool supports 116 in the illustrated embodiment also show optional alignment notches 154 and marks 156 to give the user visual proof that the dispenser halves 130 and 140 are fully engaged and that no further effort should be made to rotate them.

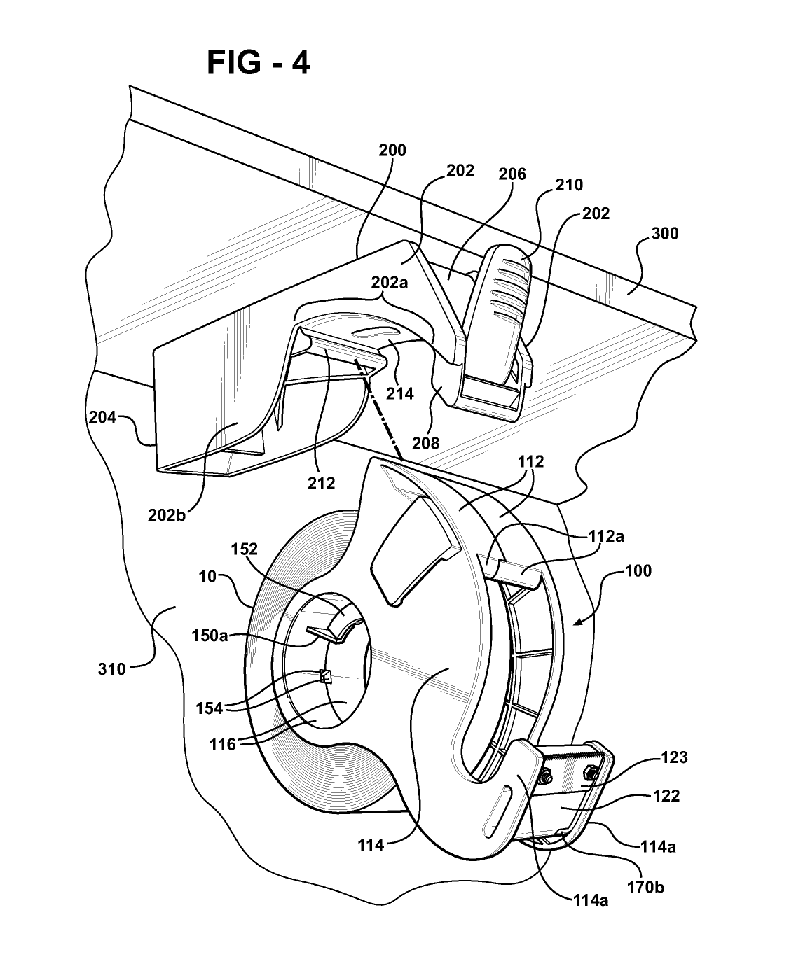

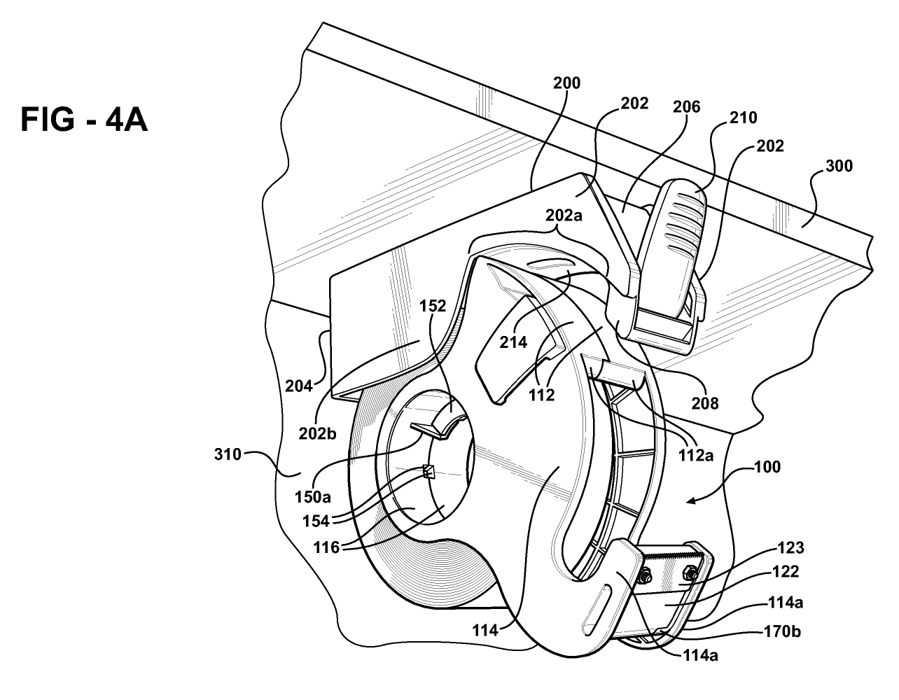

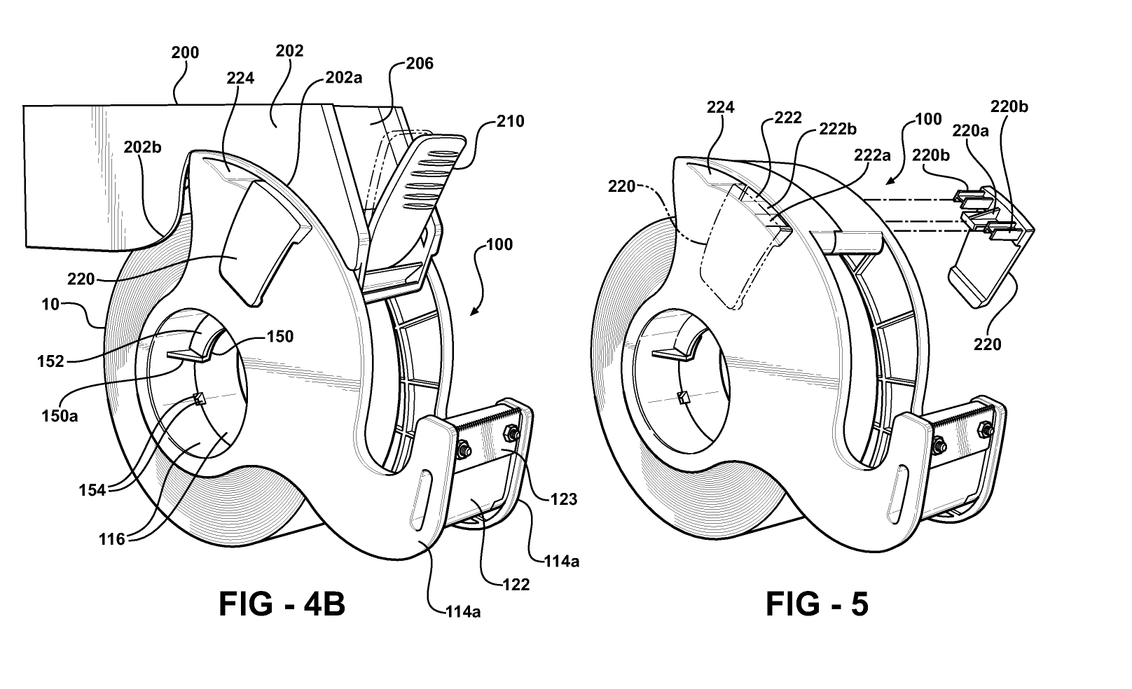

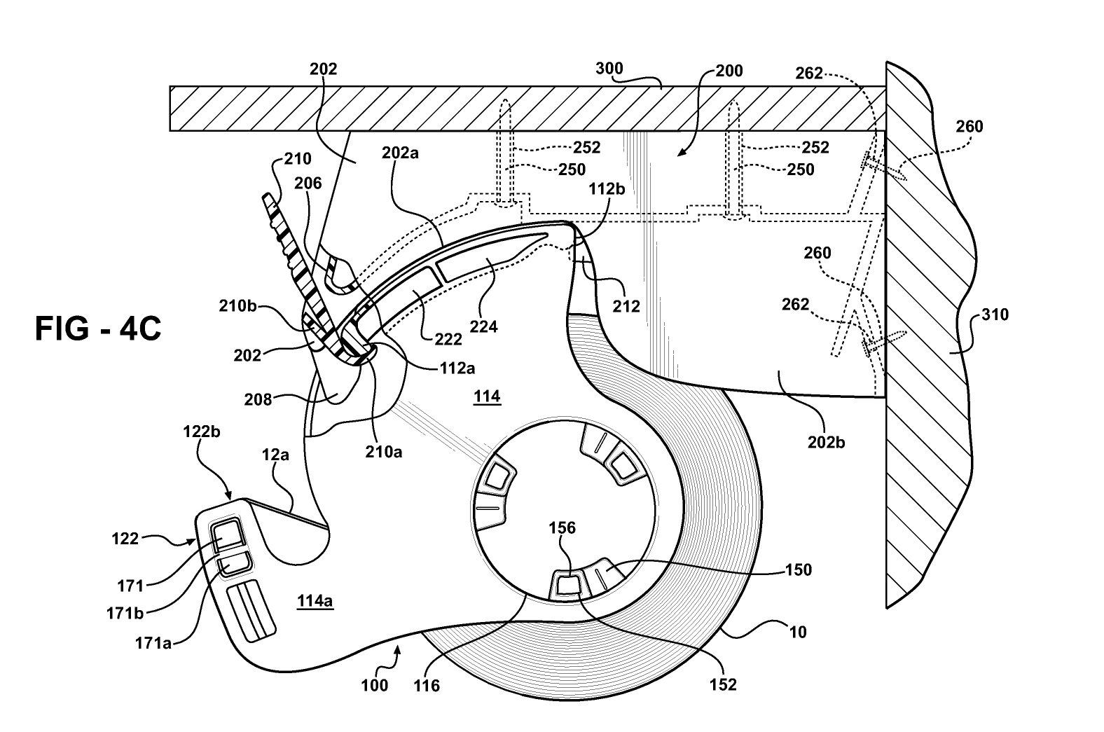

FIG. 3B shows dispenser halves 130 and 140 partially rotationally mated, and FIG. 4 shows them fully mated. It will be understood that by sizing the mating rotational locking structures for a friction fit, the rotationally mated dispenser halves make dispenser 100 rigid and very sturdy. The strength of the rotational connection is increased when the leading end 12a of duct tape 12 is retained on cutting bar 122. And the direction of cutting blade 123 is such that the act of tearing tape 12 across cutting bar 123 produces forces in the rotational mating direction, further ensuring that the rotationally mated dispenser halves stay rigidly together. However, in order to provide a further measure of assembled security, supplemental anti-rotation locking features can be provided on one or both dispenser halves to prevent the mated halves from accidentally rotating out of engagement. In the illustrated example, a hinged lock arm 171 is provided on the right-hand sidewall extension 114a, with an at-rest bias such that its lower end 171 a snaps over the lower edge of interior hollow 122c on the inside face of cutting bar 122, preventing the cutting bar portion 122 (and thus the remainder of the dispenser halves) from being rotated apart unless the lever 171 is first disengaged by pressing in its upper end from the outside of the assembled dispenser. It will be understood that other types of anti-rotational locking mechanism can be used, and that such mechanisms could be placed in this or other locations on the dispenser to prevent inadvertent disassembly of the mated dispenser halves.

Dispenser sidewalls 114 preferably have flat outer surfaces as shown throughout the Figures, to permit multiple dispensers to be stacked.

Referring next to FIGS. 4 and 4A-4C, dispenser 100 is shown being mounted underneath a cabinet (or shelf or table) 300 using an inventive storage/dispensing receptacle 200. Receptacle 200 is preferably molded or otherwise formed from the same type of plastic material as dispenser 100, with similar strengths and thicknesses, although other materials likewise can be used. Receptacle 20 has sidewalls 202, a rear wall 204, a front wall 206 with an inwardly-angled lip 208 supporting a locking lever 210, and a rear shelf or hook 212. Receptacle 200 can be secured to various horizontal and/or vertical surfaces such as the underside of shelf 300 and/or to a wall 310 with screws, nails, adhesive, hook-and-loop pieces, or any other known fastener that will securely (and preferably removably) hold receptacle 200 firmly against the mounting surface against the forces of connecting and removing dispenser 100 and of tearing tape off the receptacle-mounted dispenser. FIG. 4C shows a preferred method using screws 250 and/or 260 inserted through bores such as 252 and 262 formed in the receptacle. It will be understood that the number and location of the screws used can vary, depending on the mounting surface.

Receptacle sidewalls 202 have an arcuate lower front edge portion 202a contoured to match and matingly receive and brace the arcuate top wall 112 of dispenser 100. Referring to FIG. 4A, the first step in mounting dispenser 100 on receptacle 200 is to engage the rear edge 112b of the top wall 112 with the shelf or hook 212 at the rear of the contoured portion of the receptacle. The forward (cutting bar) end of dispenser 100 is then rotated up to mate top wall 112 fully with contoured portion 202a, at which point a lower hook end 210a (FIG. 4C) of the hinged locking lever 210 is canned into locking engagement with the front edge 112a of top wall 112 to securely lock the dispenser into the receptacle. The combination of the locking shelf and lever connections at the front and back of the dispenser top wall, and the direct bracing contact between the top wall 112 and the contoured receptacle cutout 202a over the length of the top wall, makes a strong and secure connection that allows tape 12 to be dispensed and cut from receptacle-mounted dispenser 100 with one hand.

Locking lever 210 is preferably connected to receptacle front wall 206 with a living hinge 210b, as best shown in FIG. 4C, although other types of lever connection could be used. To release dispenser 100 from the receptacle, the user merely pushes lever 210 in toward front wall 206 to release hook portion 210a from the front edge 112a of the dispenser top wall 112, the front end of the dispenser is rotated down out of the mating cutout 202a, and then the dispenser is pulled forwardly and down to release the rear edge 112b of the top wall from shelf 212.

For further storage and transport options, dispenser 100 can be provided with an integral or (preferably) removable hook or belt clip 220 on, the exterior of one of sidewalls 114, shown throughout the drawing Figures but best shown in FIG. 5. Belt clip 220 is shown as a removable snap-fit piece with locking arms 220a and 220b adapted to releasably lock with mating internal structure 222a and 222b formed in a slot such as 222 in one or both of sidewalls 114. The details of the mating fit between clip 220 and the internal structure of slot 222 is not critical to an understanding of this feature of the inventive dispenser, since similar flexible-arm type fasteners such as those made under the brand name Fastex™ are well known. Dispenser 100 shows slots 222 and 224 formed in the sidewalls 114 as byproducts of a typical molding process, and it will be understood that the forward slot 222 has been modified to releasably lock belt clip 220. It would be possible to modify both slots to receive belt clip 220, allowing the position of the belt clip to be adjusted to a user's carrying preference.

Along with all of the foregoing advantages of dispenser 100, it will also be understood that dispenser 100 allows tape roll 10 to be stood on edge on a work or storage surface without rolling away, since the front and rear ends 114a and 112b of the dispenser protrude from the roll's surface.

It will be understood that the disclosed embodiments are representative of presently preferred forms of the invention, but are intended to be illustrative rather than limiting of the invention. The scope of the invention is defined by the following claims. We accordingly claim:

What is claimed is:

1. A tape dispenser adapted to rotatably house a roll of tape, comprising:
two sidewalls, a top wall portion extending axially between the sidewalls and connecting the sidewalls above the outer diameter of a roll of tape contained in the dispenser, a spool support extending axially between the sidewalls and connecting the sidewalls through a spool portion of a roll of tape contained in the dispenser, and a cutting bar extending axially between the sidewalls and connecting the sidewalls at a forward end of the dispenser and providing a cutting element for cutting tape and a retainer surface associated with the cutting element for adhesively securing a leading end of tape from a roll of tape contained in the dispenser, the cutting bar being spaced circumferentially from a forward end of the top wall portion to define a tape-feed opening between the top wall portion and the cutting bar, wherein the dispenser is radially split into two axially registering and rotationally mating halves.

2. The tape dispenser of claim 1, wherein the surface for adhesively securing a cut end of tape on the retainer bar comprises an extended retainer surface below and in front of the cutting element and having a width coextensive with a width of a roll of tape contained in the dispenser.

3. The tape dispenser of claim 1, wherein the top wall portion of the dispenser is radially split into two halves having rotationally mating structure.

4. The tape dispenser of claim 1, wherein the spool support is radially split into two halves having rotationally mating structure.

5. The tape dispenser of claim 1, wherein the cutting bar is permanently connected at a first end to one of the sidewalls and removably connected at a free end to the other sidewall.

6. The tape dispenser of claim 1, wherein the cutting bar comprises a cutting element with a cutting edge pointing at a sticky underside of the leading end of the tape passing across the cutting bar.

7. The tape dispenser of claim 6, wherein the cutting bar is radially spaced above the top wall relative to the roll of tape between reversely-angled sidewall extensions.

8. The tape dispenser of claim 7, wherein the cutting element is substantially parallel to the surface of the roll of tape.

9. The tape dispenser of claim 7, wherein the sidewall extensions define a rounded finger well below a leading end of the tape stretched from the roll across the cutting bar.

10. The tape dispenser of claim 1, wherein the top wall portion of the dispenser has an arcuate contour generally following a curvature of the roll of tape held in the dispenser, and further including a separate receptacle adapted to removably mount the dispenser in a tape-dispensing position from a wall or an undersurface, the receptacle adapted to be secured independently to the wall or undersurface, the receptacle having a mating arcuate contoured portion adapted to matingly receive and releasably lock the arcuate top wall portion of the dispenser, such that the tape feed opening is held generally horizontally or downward and the cutting element on the cutting bar is held at an upward angle toward a sticky underside of the leading end of the tape to facilitate one-handed dispensing and tearing of tape in a downward motion from the receptacle-mounted dispenser.

11. The tape dispenser of claim 10, wherein the receptacle further comprises a rear member for releasably rotatably engaging a rear end of the top wall of the dispenser, and a forward exterior locking member adapted to releasably latch a forward end of the top wall of the dispenser.

12. The tape dispenser of claim 1, further comprising a belt clip removably secured to a sidewall of the dispenser.
